(19) United States
(12) Patent Application Publication
(10) Pub. No.: US 2021/0286394 A1
(43) Pub. Date: Sep. 16, 2021

(54) CURRENT REFERENCE CIRCUIT WITH CURRENT MIRROR DEVICES HAVING DYNAMIC BODY BIASING

(71) Applicant: Vidatronic, Inc., College Station, TX (US)

(72) Inventors: Mohammad Ahmed RADWAN, Cairo (EG); Anand Veeravalli RAGHUPATHY, Dallas, TX (US); Michael A NIX, College Station, TX (US)

(73) Assignee: Vidatronic, Inc., College Station, TX (US)

(21) Appl. No.: 16/819,088

(22) Filed: Mar. 14, 2020

(51) Int. Cl. G05F 3/26; G05F 3/20

(52) U.S. Cl. CPC G05F 3/262; G05F 3/205

(57) ABSTRACT

A current reference circuit with one or more current mirror devices having dynamic body biasing includes a voltage-to-current converter circuit having a feedback loop that includes an operational amplifier, an NMOS device, and a resistor to generate a reference current; a current mirror circuit, including one or more current mirror devices with source degeneration, to produce one or more output currents that are copies of the reference current; and a body-biasing stage including an active N-well to dynamically set a body-biasing voltage for the one or more current mirror devices.

### FIELD OF INVENTION

The invention relates to current reference circuits, and more specifically to current reference circuits with biasing schemes to dynamically adjust the body voltages for the output current mirror devices.

### BACKGROUND

A current reference circuit is an essential building block for many electronic circuits and systems. A conventional configuration is used to provide precise output currents that are proportional to the value of an input reference voltage. The input reference voltage is converted to a first current (reference current) through a resistor and a negative feedback control loop. The output currents, copied from the first current (reference current) through current mirror devices, are required to be independent of process, temperature, and supply voltage variations.

Output current mirrors significantly affect the performance of a current reference circuit. For instance, minimizing the input and output headroom of a current mirror allows the current reference circuit to support a wider range of applied load voltages. In other words, lower headroom means that the current reference circuit can support an output load with a lower power supply voltage. This emphasizes the need to reduce the threshold voltage (V_{TH}) of the current mirror devices, thereby reducing the gate-to-source voltage (V_{GS}) to obtain a reduced headroom, wherein the current mirror devices are required to operate in the saturation mode. One other imperfection of a current mirror is its output resistance, which determines the variations of the output current with an applied drain voltage at the current mirror output. Using cascode transistors and/or degeneration resistors are possible ways to enhance the output resistance, but at the cost of the voltage headroom.

FIG. 1 shows a prior art current reference circuit that provides k output currents Iₒᵤₜ [1:k]. An operational amplifier 22, through a feedback loop 18, forces the junction 14 between resistor 16 (R₀) and the source terminal of device 12 to a reference voltage V_{REF} generated from a bandgap reference 20. As a result, a first current I, that is equal to V_{REF}/R₀, is generated across components 12, 16, 30, and 40. Device 12 is an n-type metal-oxide-semiconductor (NMOS) field effect transistor, while devices 40 and devices 46(1)-46(k) (hereafter referred to in the aggregate as “devices 46s” or “mirror devices 46s”) are p-type (PMOS) devices. The resistor 30 and PMOS device 40 are used as reference devices for the corresponding devices 24(1)-24(k) (hereafter referred to in the aggregate as “devices 24s”) and devices 46s, respectively, to draw currents corresponding to the first current I. The body terminals for all PMOS devices are coupled to the power supply voltage VDD. The reference node GND corresponds to an electrical ground (i.e., zero volts).

Using larger degeneration resistors 30 and 24s can dramatically enhance the matching between the reference device 40 and mirror devices 46s, as well as reducing the flicker noise contribution from these mirror devices 46s at the outputs. However, this current reference circuit suffers from a limited headroom due to the voltage drop across these larger resistors and also has increased V_{TH} for the mirror devices 46s when their body-to-source voltage (V_{BS}) increases.

FIG. 2 shows another prior art current reference circuit with a single modification from the circuit in FIG. 1. The body terminal for each of the mirror devices 40 and mirror devices 46s is coupled to its source, instead of VDD as in FIG. 1. The main purpose is to decrease the threshold voltage of these devices as V_{BS} is down to zero volts. This current reference circuit provides a more optimized headroom at the outputs and high output resistance.

However, a drawback in the circuit in FIG. 2 is the area overhead when the body of each device has a separate wiring in an electrical path to its source. As a result, a separate n-type well implant (N-Well) should be placed under each device from the devices 40 and devices 46s to couple the body independently to the source. According to strict layout rules, each N-Well is required to extend over the device active area to enclose it from every side with some margin, in micrometers. In addition, each N-Well should be spaced from its neighboring wells by a few micrometers. These enclosure and spacing rules for different wells result in a significant overhead in the current mirror area, and, therefore, the current mirror devices cannot be efficiently placed in proximity. When the number (k) of the current outputs required by the system is large, the area overhead becomes severe, so is the potential mismatch between the mirror devices, especially in high-precision applications that require large physical area for the mirror devices for better matching. In such cases, the overhead can be in thousands of square micrometers or more, thereby causing noticeable shift in the threshold voltage between the output devices. Devices with a shared body connection, as in FIG. 1, normally have a single well implant for all the current mirror devices, and therefore the current reference circuit does not suffer from such area penalty.

One possible solution to the area overhead issue is the modified implementation shown in FIG. 3, wherein the body terminal for each of the mirror devices 40 and devices 46s is coupled to the source of device 40, thereby having a zero body-to-source voltage (V_{BS}) for all PMOS devices. However, the impact of any body leakage may introduce an error between the current in device 40 and the current in resistor 30, thereby adding inaccuracy in the current mirror ratio especially at high temperatures. Such an impact becomes severe in low power circuits where the leakage current may be comparable to the reference current, and/or when the number of output currents (k) is large.

FIG. 1, FIG. 2, and FIG. 3 show prior art current reference circuits comprising source-degenerated current mirrors. These circuits suffer from limited headroom characteristics, area overhead, or inaccuracy due to body leakage. Therefore, there is still a need for new current reference circuits with improved headroom characteristics, without a significant impact to the area, and/or maintaining high accuracy.

### SUMMARY OF THE INVENTION

In one aspect, embodiments of the invention relate to a current reference circuit, wherein an auxiliary body-biasing circuit is introduced to generate dynamic body voltages for the output current mirror devices, in order to adjust the threshold voltage to have a lower voltage headroom for the current mirror devices, without much area overhead due to employing body-to-source connections for the lower headroom, and maintaining high accuracy. Embodiments of the invention are suitable for applications that require high-precision reference currents with an efficient and compact layout, and/or when low voltage/low power operations are desired.

In one aspect, embodiments of the invention relate to current reference circuits each with one or more current mirror devices having dynamic body biasing. A current reference circuit in accordance with one embodiment of the invention comprises a voltage-to-current converter circuit having a feedback loop that includes an operational amplifier, an NMOS device, and a resistor to generate a reference current; a current mirror circuit, including one or more current mirror devices with source degeneration, to produce one or more output currents that are copies of the reference current; and a body-biasing stage comprising an active N-well to dynamically set a body-biasing voltage for the one or more current mirror devices.

In accordance with embodiments of the invention, the current reference circuit is implemented as on-chip or using discrete components. The current reference device may be formed using a complementary metal-oxide-semiconductor (CMOS) process or a silicon on insulator (SOI) process. The feedback loop works as a voltage-to-current converter to provide the reference current proportional to an input reference voltage. The current mirror circuit employs a simple diode configuration, a stacked cascode configuration, or a wide-swing cascode configuration.

In accordance with some embodiment of the invention, the body-biasing stage is in a stacked configuration, and a threshold voltage magnitude of lower stacked devices is adjusted to be lower than a threshold voltage magnitude of the one or more current mirror devices by at least an overdrive voltage of the lower stacked devices in order to operate the one or more current mirror devices in a saturation mode.

In accordance with some embodiments of the invention, the body-biasing stage is in a wide-swing cascode configuration, wherein the voltage-to-current circuit comprises a reference cascode device, the current mirror circuit comprises one or more corresponding cascode devices respectively coupled to the one or more current mirror devices, and the body-biasing stage comprises a corresponding cascode device. In accordance with embodiments of the invention, the gate electrodes of all cascode devices in the voltage-to-current circuit, the current mirror circuit, and the body-biasing stage are coupled to a bias voltage such that an optimum swing is achieved when all current mirror devices operate in a saturation mode.

Other aspects of the invention would become apparent with the following detailed description and the accompanied drawings.

### BRIEF DESCRIPTION OF DRAWINGS

The appended drawings illustrate several embodiments of the invention and are not to be considered limiting of its scope, for the invention may admit to other equally effective embodiments.

FIG. 1 shows a circuit diagram of a prior art current reference circuit comprising a source-degenerated current mirror with a common connection for all body terminals.

FIG. 2 shows a circuit diagram of a prior art current reference circuit comprising a source-degenerated current mirror with body-to-source wiring for each device.

FIG. 3 shows a circuit diagram of a prior art current reference circuit comprising a source-degenerated current mirror with a shared body connection to the source of the reference mirror device.

FIG. 4 shows a current reference circuit employing a dynamic body-biasing stage for a source-degenerated current mirror in a diode configuration in accordance with one embodiment of the invention.

FIG. 5 shows a current reference circuit employing a dynamic body-biasing stage for a source-degenerated current mirror in a wide-swing cascode configuration in accordance with one embodiment of the invention.

FIG. 6 shows a current reference circuit employing a dynamic body-biasing stage for a source-degenerated current mirror in a stacked configuration in accordance with one embodiment of the invention.

### DETAILED DESCRIPTION

Aspects of the present disclosure are shown in the above-identified drawings and are described below. In the description, like or identical reference numerals are used to identify common or similar elements. The drawings are not necessarily to scale, and certain features may be shown exaggerated in scale or in schematic in the interest of clarity and conciseness.

Embodiments of the invention relate to current reference circuits each comprising a dynamic body-biasing stage (e.g., an active N-Well biasing circuit) to dynamically adjust the body voltage for the output current mirror devices in order to improve the voltage headroom characteristics without much area overhead that would result from the use of a separate N-Well implant for each current mirror device. In accordance with embodiments of the invention, an auxiliary body-biasing circuit may be used as a buffer stage to supply the body leakage currents and dynamically bias the body of all mirror devices. In accordance with embodiments of the invention, a feedback loop is used as a voltage-to-current converter to generate a first current (also referred to as “reference current”) that is proportional to a given reference voltage V_{REF}. In accordance with embodiments of the invention, a current mirror is used to generate output currents copied from the first current. A current mirror could employ a simple diode configuration, a stacked configuration, or a wide-swing cascode configuration. Without the invention, a current reference circuit can suffer from either limited voltage headroom, inaccuracy, or large area overhead due to employing body-to-source connections for lower headroom. Those skilled in the art, with the benefit of this disclosure will appreciate that same or similar features are equally applicable to any system, the operation of which requires high-precision reference currents with a compact area for the current reference circuit and/or when a low voltage/low power operation is desired.

In accordance with embodiments of the invention, a current reference circuit can be implemented on a microchip, such as a semiconductor integrated circuit, or can be implemented out of discrete components. In accordance with some embodiments of the invention, the transistors can be metal-oxide-semiconductor (MOS) devices formed using a complementary metal-oxide-semiconductor (CMOS) fabrication technology. However, embodiments of the invention are not limited to such transistor devices and/or fabrication processes. Other suitable devices and/or fabrication processes, such as silicon on insulators (SOI), may be similarly employed. Throughout this disclosure, the terms “current reference circuit,” and “voltage-to-current converter” may be used interchangeably depending on the context. Likewise, the terms “body-biasing stage” and “body-biasing circuit” may be used interchangeably.

As noted above, a current mirror circuit of the invention may be implemented in a simple diode configuration, a stacked configuration, or a wide-swing cascode configuration. FIG. 4 shows an exemplary current reference circuit with an auxiliary body-biasing stage in a diode configuration. This exemplary circuit comprises a voltage-to-current converter circuit 100 to convert a given reference voltage V_{REF} to a reference current I and a current mirror circuit 200 to produce output currents as copies of the reference current I. In addition, an auxiliary body-biasing stage 300 is used as a buffer stage to generate a well-defined voltage at junction 204 to supply the body of all current mirror devices in the current mirror circuit 200. This approach allows a single N-Well implant to be placed under all current mirror devices with an efficient layout and without much area overhead. The implementation of the body-biasing stage 300 is similar to that of the branch carrying current I in the voltage-to-current converter circuit 100. The voltage characteristics of the body-biasing stage 300 is also similar to that in the branch carrying current I in the voltage-to-current converter circuit 100.

In the body-biasing stage 300, the gate electrode of NMOS device 208 is coupled to the operational amplifier output 22 that also controls the gate electrode of device 12 through a feedback loop 18. A resistor 216 is placed between the source of NMOS device 208 and the reference node GND, similarly to the implementation of resistor 16. A PMOS device 212 serves as a mirror device to draw a copy of the current I. The drain terminals of devices 208 and 212 are coupled together. The gate electrodes of mirror devices 40, 212, and 46s are coupled together. A degeneration resistor 220 is placed between the source terminal 204 of device 212 and the power supply voltage VDD. The value of the degeneration resistor 220 may be adjusted to have the same voltage drop as that for resistors 30 and 24s to have zero body-to-source voltage (V_{BS}) for all PMOS current mirror devices. In some embodiments of the invention, the degeneration resistor 220 may comprise one or more series resistor segments such that the body-biasing stage can provide one or more bias voltages through the one or more resistor segments to separately bias the body voltages of the output mirror devices. The body terminals of all PMOS current mirror devices are coupled to the body-biasing stage output at 204.

The body-biasing stage output at 204 represents a dynamic voltage that can be changed according to the circuit operating conditions. For instance, when the reference circuit is powered down, the voltage of the body-bias junction 204 (i.e., body-bias voltage) is pulled up to that of the power supply rail, because the gate voltage of device 208 is set to turn-off the current of the body-biasing stage 300. During normal operations, the feedback loop 18 controls the gate voltage of devices 12 and 208, thereby dynamically adjusting the body-bias voltage to its desired value. The devices 208 and 212 should be well-matched in their layouts to devices 12 and 40, respectively. Similarly, resistors 216 and 220 should be well-matched to resistors 16 and 30, respectively. The matching design is to maintain robust operations against process and mismatch variations that may affect the precision of the body-biasing stage 300.

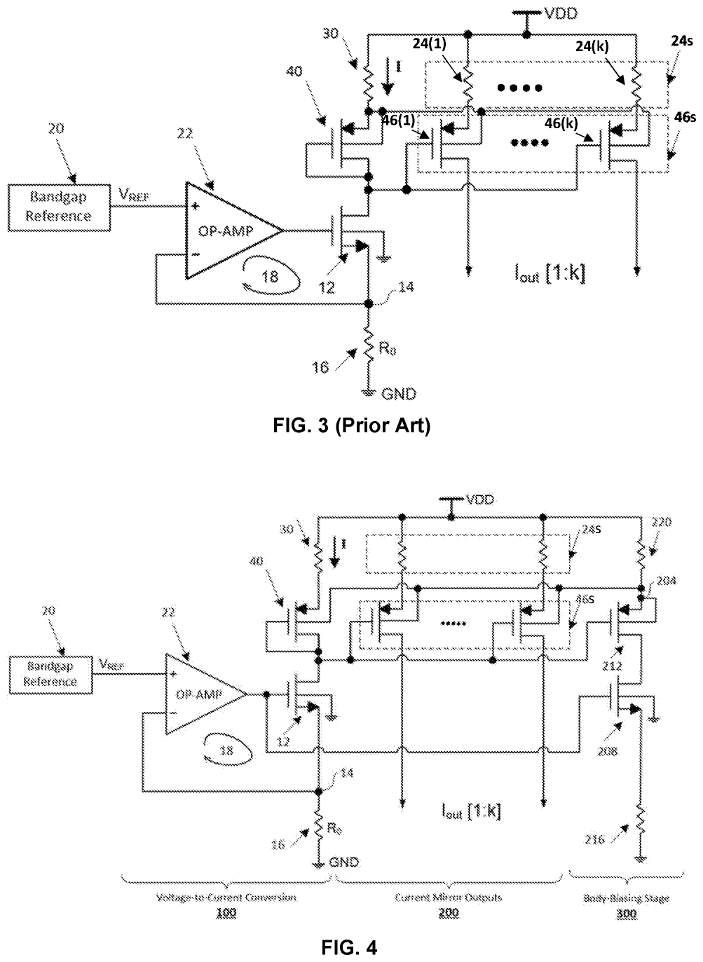

In contrast to the circuit of FIG. 3, the body-biasing stage 300 of the embodiment in FIG. 4 dynamically provides an output voltage (a body-biasing voltage) at 204 that supplies the leakage current of all body terminals and provides a controllable and well-defined body-biasing voltage for the mirror devices. In accordance with embodiments of the invention, the produced body-to-source voltage (V_{BS}) can be positive, zero, or negative.

In accordance with embodiments of the invention, the produced body-to-source voltage (V_{BS}) for all current mirror devices is insensitive to the power supply voltage (VDD) variations, when the body and source for current mirror devices both have fixed voltage drops, through degeneration resistors, from VDD. As a result, the body continues to track the source for each current mirror device and hence the threshold voltage becomes insensitive to VDD variations.

In accordance with embodiments of the invention, the copied current in the body-biasing stage 300 may be less than the current I (e.g., at a known ratio) such that both the current and area consumption of the body-biasing circuit would have a minimized impact on the current consumption and total area of the current reference circuit.

In accordance with some embodiments of the invention, the gate width of device 212 and the value of resistor 220 can be adjusted to control the generated body-biasing voltage at 204. The generated body-biasing voltage can even be lower than the source voltage to obtain a negative body-to-source voltage (V_{BS}) for further reduction of the threshold voltage and improvement in the headroom. However, the negative V_{BS} voltage should be carefully selected to avoid forward biasing of a body-to-diffusion junction that could lead to noticeable leakage currents, and hence an incorrect mirror operation.

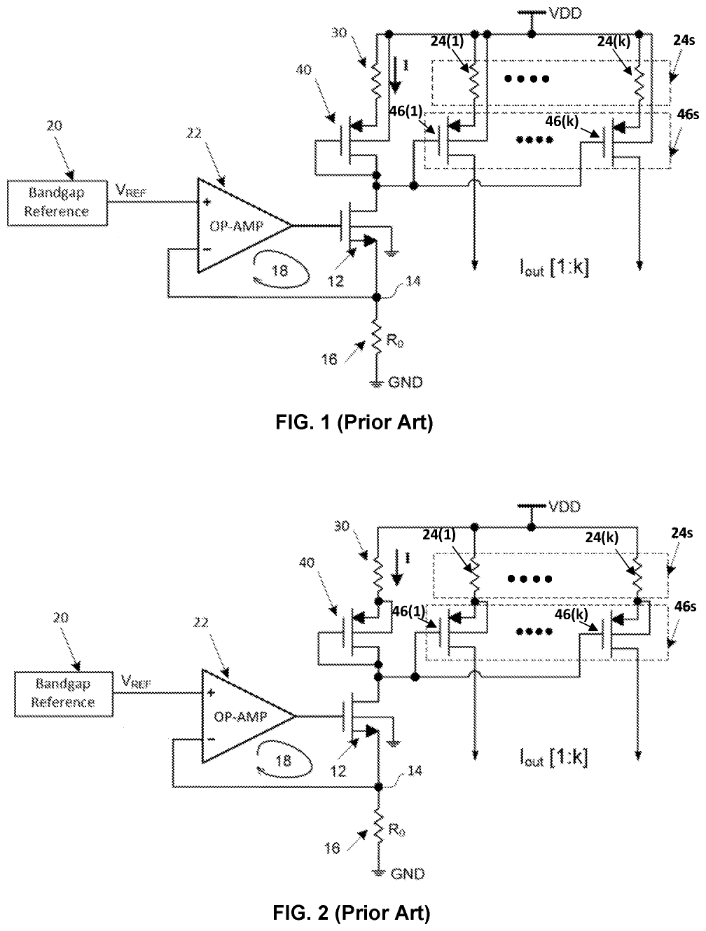

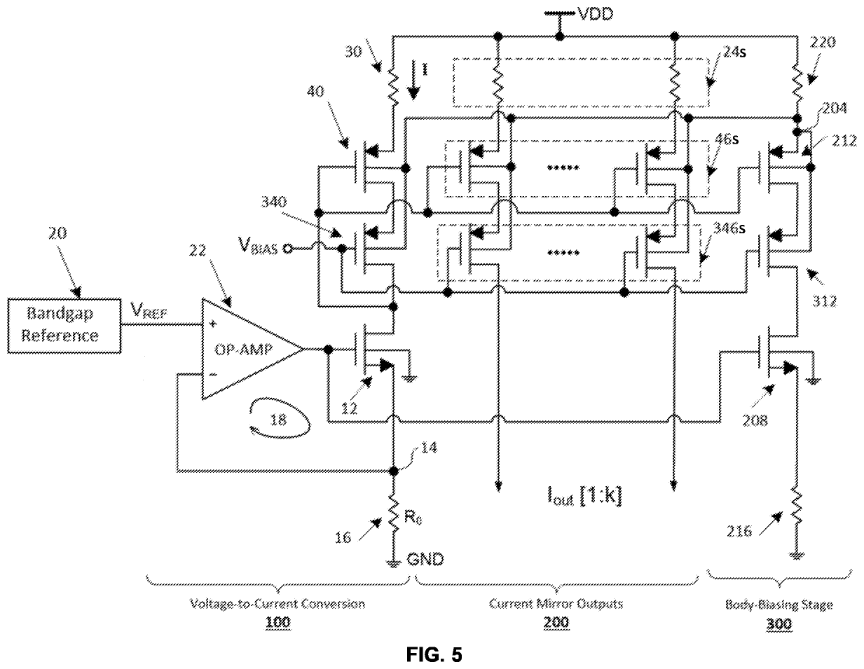

While the implementation in FIG. 4 is in a diode configuration, FIG. 5 shows a possible implementation of another exemplary current reference circuit of the invention, in which the dynamically body-biased current mirror devices are in a wide-swing cascode configuration. The diode configuration in FIG. 4 may suffer from channel-length modulations. When the load voltage varies, the size of the drain-channel depletion region may vary. As a result, the effective channel length and, thereby, the output current may vary. The wide-swing cascode current mirror does not have such a current mismatch, but at the cost of additional voltage headroom due to the added cascode devices. As shown in FIG. 5, a cascode device 340 is placed as a reference cascode device in the branch carrying the reference current I in the voltage-to-current converter circuit 100. The devices 346s in the output branches (i.e., the current mirror circuit) are cascode devices corresponding to the cascode device 340. Similarly, a corresponding cascode device 312 is added to the body-biasing stage 300. The gate electrodes for the current mirror devices 40, 212, and 46s are coupled to the drain of the cascode device 340. The gate electrodes of the cascode devices 340, 312, and 346s are coupled to a bias voltage V_{BIAS} that may be generated from a biasing cell inside the bandgap reference 20 such that an optimum swing can be achieved when all current mirror devices operate in the saturation mode. The body-biasing stage 300 produces a body-biasing voltage at 204 that supplies the body of all PMOS current mirror devices. The body-biasing solution provides a compact area by using a single N-Well implant for all current mirror devices in the cascode configuration to reduce voltage headroom, instead of 2(k+1) separate N-Wells as in solution illustrated in FIG. 2. In accordance with embodiments of the invention, the resistor 220 and sizing of devices 212 and 312 may be adjusted to control the generated body-biasing voltage at 204 to achieve an appropriate V_{TH} for the current mirror devices.

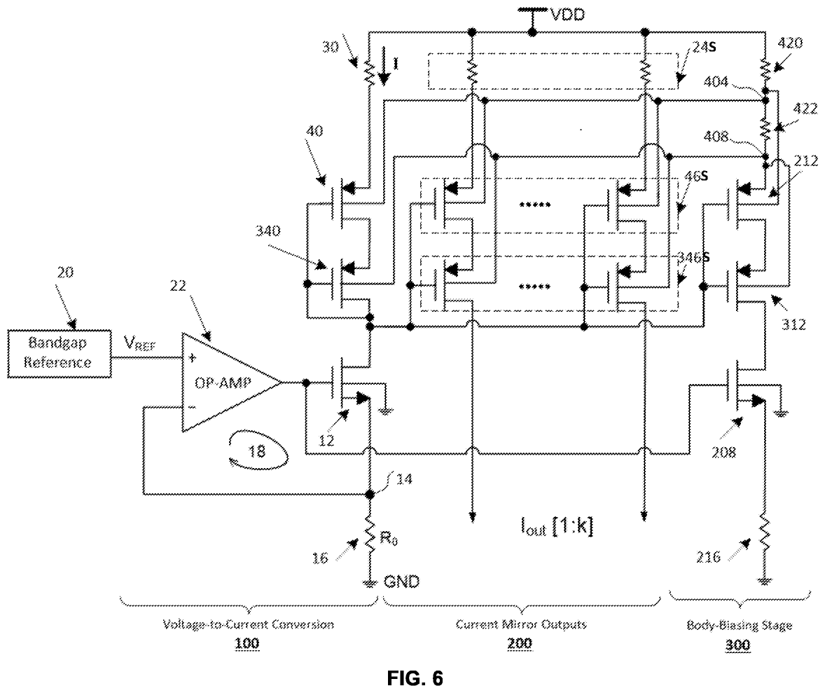

In addition to the diode configuration shown in FIG. 4 and the wide-swing cascode configuration shown in FIG. 5, a current reference circuit of the invention may also be implemented in a stacked configuration. FIG. 6 shows a possible implementation of a current reference circuit in accordance with one embodiment of the invention, wherein the dynamically body-biased current mirror devices are in a stacked configuration. In the stacked configuration, the gate electrodes of the upper current mirror devices 40, 212, and 46s, and the gate electrodes of the stacked devices 340, 312, and 346s are all coupled together. This eliminates the need to employ an additional biasing cell to generate V_{BIAS} for the cascode devices 340, 312, and 346s as in the wide-swing cascode configuration in FIG. 5. The stacked devices with such series connections can provide a high output resistance, similar to the effect of increasing the channel length in the diode configuration in FIG. 4. In contrast to the diode configuration in FIG. 4, the stacked and cascode configurations both do not suffer from channel length modulations. In a conventional stacked configuration, the mirror transistors 40, 212, and 46s normally operate in a triode mode, thereby degrading the output resistance. The source-to-drain voltage of these devices should be greater than the overdrive voltage (V_{SD-SAT}) in order to operate in the saturation mode.

In accordance with embodiments of the invention, in order to operate the mirror devices in the saturation mode, the threshold voltage magnitude of the stacked devices 340, 312, and 346s may be adjusted to be lower than the threshold voltage magnitude of the mirror devices 40, 212, and 46s by at least the overdrive voltage of the stacked devices 340, 312, and 346s. For example, the saturation condition for device 40 is determined from the following inequality:

|V_{TH,340}|<|V_{TH,40}|−V_{SD-SAT,340}

In order to satisfy such conditions, the gate widths and gate lengths of the stacked devices are selected to adjust V_{SD-SAT}, and the body voltages of the upper and lower devices are adjusted to modify their threshold voltages. In accordance with embodiments of the invention, two body-biasing outputs may be generated from the body-biasing stage 300 to separately adjust the bodies of the upper and lower current mirror devices. Two series resistors 420 and 422 may be used to provide two different outputs at junctions 404 and 408 to bias the bodies of the upper devices 40, 212, and 46s, and the lower devices 340, 312, and 346s, respectively. In accordance with embodiments of the invention, the resistors 420 and 422, and sizing of devices 212 and 312 may be adjusted to select an appropriate V_{TH} for the upper and lower current mirror devices to meet the operating point requirements. In accordance with some embodiments of the invention, the stacked devices 340, 312, and 346s may be low threshold voltage devices (LVT) to help achieve the operating point conditions.

In accordance with embodiments of the invention, the current mirror devices for each of the discussed current mirror configurations can be standard threshold voltage devices (SVT devices), high threshold voltage devices (HVT devices), low threshold voltage devices (LVT devices), or super-low threshold voltage devices (SLVT devices). In accordance with embodiments of the invention, the single cascode configuration in FIG. 5 and the single stacked configuration FIG. 6 can be extended to employ double cascode, double stacked devices, or even more.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A current reference circuit with one or more current mirror devices having dynamic body biasing, comprising:
a voltage-to-current converter circuit comprising a feedback loop that comprises an operational amplifier, an NMOS device, and a resistor to generate a reference current;
a current mirror circuit, comprising the one or more current mirror devices with source degeneration, to produce one or more output currents that are copies of the reference current; and
a body-biasing stage comprising an active N-well to dynamically set a body-biasing voltage for the one or more current mirror devices.

2. The current reference circuit of claim 1,
wherein the current reference circuit is implemented as on-chip or using discrete components.

3. The current reference circuit of claim 1,
wherein the current reference device is formed using a complementary metal-oxide-semiconductor (CMOS) process or a silicon on insulator (SOI) process.

4. The current reference circuit of claim 1,
wherein the feedback loop works as a voltage-to-current converter to provide the reference current proportional to an input reference voltage.

5. The current reference circuit of claim 1,
wherein the current mirror circuit employs a simple diode configuration, a stacked cascode configuration, or a wide-swing cascode configuration.

6. The current reference circuit of claim 1,
wherein the body-biasing stage comprises:
a first n-type transistor with a gate thereof coupled to an output of the operational amplifier in the voltage-to-current converter circuit,
a first resistor placed between a source of the first n-type transistor and a reference node,
a p-type transistor serving as a mirror device, wherein the p-type transistor is coupled to a drain of the first n-type transistor, and
a second resistor placed between a power supply and a source of the p-type transistor, wherein the second resistor serves as a degeneration resistor coupled to the power supply.

7. The current reference circuit of claim 6,
wherein the p-type transistor in the body-biasing stage is in a diode configuration, a stacked cascode configuration, or a wide-swing cascode configuration, and is matched to the one or more current mirror devices.

8. The current reference circuit of claim 6,
wherein the p-type transistor in the body-biasing stage is a standard threshold voltage device (SVT), a high threshold voltage device (HVT), a low threshold voltage device (LVT), or a super-low threshold voltage device (SLVT).

9. The current reference circuit of claim 6,
wherein the second resistor comprises one or more series resistor segments such that the body-biasing stage can provide one or more bias voltages through the one or more resistor segments to separately bias the body voltages of the one or more current mirror devices.

10. The current reference circuit of claim 6,
wherein the second resistor value and sizing of the p-type transistor in the body-biasing stage may be adjusted to control the generated body-biasing voltage, thereby modifying a threshold voltage and headroom for the one or more current mirror devices.

11. The current reference circuit of claim 6,
wherein the body-biasing stage can provide a positive, zero, or negative body-to-source voltage for the one or more mirror devices.

12. The current reference circuit of claim 11,
wherein the body-to-source voltage is insensitive to voltage variations at the power supply, where the generated body-biasing voltage tracks the voltage variations at the power supply, thus provides a robust threshold voltage across varying power supplies.

13. The current reference circuit of claim 1,
wherein the body-biasing stage is in a stacked configuration, and a threshold voltage magnitude of lower stacked devices is adjusted to be lower than a threshold voltage magnitude of the one or more current mirror devices by at least an overdrive voltage of the lower stacked devices in order to operate the one or more current mirror devices in a saturation mode.

14. The current reference circuit of claim 13,
wherein the second resistor and the sizing of stacked p-type transistor are adjusted to control the generated body-biasing voltage, thereby modifying the threshold voltage of the one or more current mirror devices such that the threshold voltage magnitude of the lower stacked devices is lower than the threshold voltage magnitude of the one or more current mirror devices by at least the overdrive voltage of the lower stacked devices.

15. The current reference circuit of claim 1,
wherein the body-biasing stage is in a wide-swing cascode configuration, wherein the voltage-to-current circuit comprises a reference cascode device, the current mirror circuit comprises one or more corresponding cascode devices respectively coupled to the one or more current mirror devices, and the body-biasing stage comprises a corresponding cascode device.

16. The current reference circuit of claim 15,
wherein gate electrodes of all cascode devices in the voltage-to-current circuit, the current mirror circuit, and the body-biasing stage are coupled to a bias voltage such that an optimum swing is achieved when all current mirror devices operate in a saturation mode.
